(19) United States
(12) Patent Application Publication
(10) Pub. No.: US 2010/0061925 A1
(43) Pub. Date: Mar. 11, 2010

(54) MANUFACTURING METHOD FOR TITANIUM HYDRIDE POWDERS

(76) Inventors: Wonsik Lee, Seongnam (KR); Jinman Jang, Pyungtaek (KR); Sehyun Ko, Seongnam (KR); Sangyong Park, Osan (KR)

Correspondence Address: IPLA P.A., 3550 WILSHIRE BLVD., 17TH FLOOR, LOS ANGELES, CA, 90010, US

(21) Appl. No.: 12/439,806

(22) PCT Filed: Sep. 5, 2007
(86) PCT No.: PCT/KR2007/004264

§ 371 Date: Mar. 3, 2009

(30) Foreign Application Priority Data
Sep. 7, 2006 (KR) 10-2006-0086472
Sep. 5, 2007 (KR) PCT/KR2007/004264

(51) Int. Cl. C01B 6/02

(52) U.S. Cl. 423/645

(57) ABSTRACT

It is an object of the present invention to provide a method of manufacturing titanium hydride powder that is capable of manufacturing titanium hydride by using titanium scrap generated during machining as a raw material. Further, according to the method of manufacturing titanium hydride powder, since the titanium scrap is hydrogenated and changed into powder at the same time for a short time, it is possible to reduce the number of processes and manufacturing cost and to improve productivity. In order to achieve the object, according to an embodiment of the present invention, a method of manufacturing titanium hydride powder includes charging titanium scrap into a reaction container, removing air in the reaction container and supplying hydrogen gas to the reaction container, and performing ball milling.

### TECHNICAL FIELD

The present invention relates to a method of manufacturing titanium hydride powder. More particularly, the present invention relates to a method of manufacturing titanium hydride powder that uses titanium or titanium alloy scrap generated during machining as a raw material, and performs ball milling to hydrogenate the titanium or titanium alloy scrap and to change the titanium or titanium alloy scrap into powder at the same time. Accordingly, it is possible to significantly reduce manufacturing cost and to improve productivity.

### BACKGROUND ART

Titanium is a light and strong material. And titanium has been widely used as a material of an aircraft body, a wear-resistant material, a high-strength alloy material, a tool material, a functional ceramic material, a heat-resistant material, a surface coating material, and a catalyst material. Accordingly, the amount of scrap generated after the machining of titanium, particularly, turning chips generated during lathe machining have significantly increased. However, currently, the turning chips are recycled only in a titanium melting process.

Meanwhile, titanium hydride, particularly, TiH₂ powder is used as an intermediate product, which is dehydrogenated to manufacture titanium metal powder. As the demand for titanium has increased in recent years, the demand for TiH₂ powder has also significantly increased.

The following method of manufacturing powder has been disclosed in Korean Patent Publication No. 1999-0044580 as a method of manufacturing titanium hydride powder. In the method of manufacturing powder, when a titanium sponge massive body manufactured by a Kroll process is hydrogenated, the titanium sponge massive body is charged into a vacuum furnace in order not to be contaminated by oxygen. The massive body is heated in the vacuum furnace at a temperature of 1000° C. or less, and is then hydrogenated in a hydrogen gas atmosphere, thereby obtaining a hydrogenated titanium massive body having a hydrogen content of 3.5 to 4.5% by weight. After that, the hydrogenated titanium massive body is pulverized and classified to manufacture powder.

### DISCLOSURE OF INVENTION

### Technical Problem

However, a high-temperature vacuum reactor is required to perform the above-mentioned method, and a process for heating a reaction container and a process for pulverizing the hydrogenated massive body need to be performed in the above-mentioned method. For this reason, processes of the above-mentioned method are complicated, long time is required to manufacture powder, and degree of danger is high during working. Therefore, there are problems in that productivity deteriorates and manufacturing cost increases due to high equipment cost.

Further, “A Study on the Synthesis of Titanium Hydride by SHS (Self-propagating High-temperature Synthesis) Method and the Preparation of Titanium Powder” published in Journal of the Korean Industrial and Engineering Chemistry (Volume 5, Number 2, 1994) discloses the following method that further reduces manufacturing cost in comparison with a conventional method. In this method, a titanium sponge is charged into a chemical reactor, and hydrogen gas is supplied to the chemical reactor. Then, a reaction is generated by a heating element at one position of a reactant, and the titanium sponge is hydrogenated by spontaneous reactions at the other positions thereof. After that, titanium hydride powder is obtained by a pulverization process.

However, a high-temperature chemical reactor is also required to perform this method, and a process for pulverizing the titanium sponge should be performed after the hydrogenation of the titanium sponge in order to obtain titanium hydride powder in this method. For this reason, processes of this method are complicated and this method has a limitation on the reduction of manufacturing cost.

### Technical Solution

The present invention has been made to solve the above-mentioned problems, and it is an object of the present invention to provide a method of manufacturing titanium hydride powder that is capable of manufacturing titanium hydride by using titanium scrap generated during machining as a raw material. Further, according to the method of manufacturing titanium hydride powder, since the titanium scrap is hydrogenated and changed into powder at the same time for a short time, it is possible to reduce the number of processes and manufacturing cost and to improve productivity.

In order to achieve the object, according to an aspect of the present invention, a method of manufacturing titanium hydride powder includes charging scrap containing titanium into a reaction container, removing air in the reaction container and supplying hydrogen gas to the reaction container, and performing ball milling.

According to the aspect of the present invention, scrap containing titanium, that is, titanium or titanium alloy scrap (hereinafter, referred to as “titanium scrap”) may be used as a raw material, and ball milling may be performed on the scrap in a hydrogen atmosphere. If ball milling is performed, strong mechanical energy is applied to the titanium scrap by balls moving in the container. The mechanical energy causes a titanium hydrogenation reaction, which is represented by the following Formula 1, between a titanium ingredient of the scrap containing titanium and hydrogen (H₂) existing in an atmosphere.

Ti+H₂→TiH₂(ΔH°=−34.5 kcal/mol) [Formula 1]

Meanwhile, the above-mentioned reaction is an exothermic reaction that generates considerable heat. Accordingly, when the reaction is performed to some extent, the reaction is performed due to combustion waves that are caused by the heat of reaction generated due to a self-reaction. For this reason, the reaction can progress at a very high rate without energy supplied from the outside.

Further, since the above-mentioned reaction is caused by mechanical energy generated by a ball mill, it is possible to hydrogenate scrap and to change scrap into powder at the same time. As a result, a separate process for pulverizing hydride does not need to be performed, so that productivity is improved. Furthermore, since not expensive titanium powder or a titanium sponge but titanium scrap is used as a raw material, manufacturing cost is significantly reduced and it is helpful to recycle titanium scrap.

Further, the above-mentioned method may further include maintaining the titanium hydride powder for a predetermined time after the performing of the ball milling. When the scrap is sufficiently changed into powder by ball milling, the hydrogenation is performed due to heat of a self-reaction. Accordingly, mechanical energy does not need to be additionally applied to the scrap. For this reason, it is preferable that ball milling time be minimized and the scrap be maintained for a predetermined time.

Examples of the titanium scrap may include various chips, such as a turning chip, a chip, and powder that are generated during the machining of titanium. In this case, the “turning chip” means a by-product that is generated due to lathe machining and curved in the shape of a thin strip. The “chip” means a by-product that is generated due to machining and has the shape of a piece. The “powder” means a by-product that is generated due to machining and has the shape of fragments.

Further, it is preferable that the pressure of the hydrogen gas be in the range of 1 to 100 bar. The reason for this is as follows: if the pressure of the hydrogen gas is lower than 1 bar, a hydrogenation reaction is not performed well. Even though the pressure of the hydrogen gas increases up to 100 bar or more, a reaction rate hardly increases but equipment cost increases. Therefore, it is not economical. And it is more preferable that the pressure of the hydrogen gas be in the range of 3 to 20 bar.

Furthermore, the ball milling may be performed at 50 rpm or more at room temperature. Since it is possible to obtain sufficiently high reaction rate even at room temperature in the method of manufacturing titanium hydride according to the aspect of the present invention, the scrap does not need to be heated using a separate high-temperature reaction container. If the ball milling is performed below 50 rpm, the amount of mechanical energy applied to powder is not enough to cause a self-exothermic reaction. For this reason, it is preferable that the ball milling be performed at 50 rpm or more.

In addition, the ball milling may be performed for 60 seconds to 1 hour. The ball milling time required to sufficiently perform a titanium hydrogenation reaction depends on the rpm of the ball mill, temperature, or hydrogen pressure. However, if the ball milling is performed for a time shorter than 60 seconds, it is difficult to sufficiently make powderization and to cause a self-hydrogenation reaction. If the ball milling is performed for 1 hour or more, it is not economical. And it is more preferable that the ball milling be performed for 300 seconds to 30 minutes.

### ADVANTAGEOUS EFFECTS

As described above, in the method of manufacturing titanium hydride according to the aspect of the present invention, it is possible to directly generate hydride from titanium scrap for a short time without performing a hydrogenation process in a high-temperature chemical reactor. Accordingly, it is helpful to recycle titanium scrap, and it is possible to significantly reduce energy cost and equipment cost. As a result, manufacturing cost is significantly reduced.

Further, in the method of manufacturing titanium hydride according to the aspect of the present invention, it is possible to manufacture titanium hydride in several to several tens minutes. Therefore, productivity is significantly improved.

### BRIEF DESCRIPTION OF THE DRAWINGS

FIG. 1 is a schematic view illustrating a method of manufacturing titanium hydride powder according to an embodiment of the present invention.

FIG. 2 is a graph showing a relationship between milling time and the amount of absorbed hydrogen when TiH₂ powder is manufactured by the method according to the embodiment of the present invention.

FIG. 3 is a graph showing results of X-ray diffraction analysis of the TiH₂ powder that is manufactured by the method according to the embodiment of the present invention.

FIG. 4 is a graph showing results of DTA analysis of the TiH₂ powder that is manufactured by the method according to the embodiment of the present invention.

### BEST MODE FOR CARRYING OUT THE INVENTION

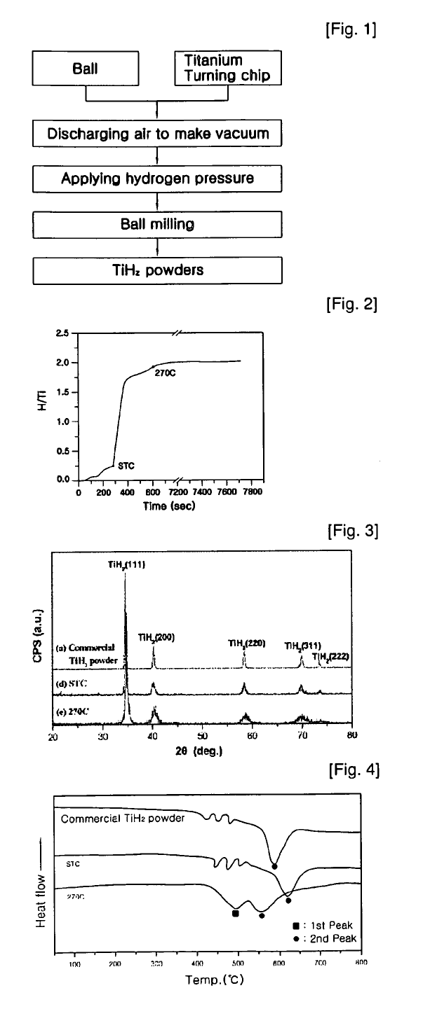

FIG. 1 is a schematic view illustrating a method of manufacturing titanium hydride powder according to an embodiment of the present invention. FIG. 2 is a graph showing a relationship between milling time and the amount of absorbed hydrogen when TiH₂ powder is manufactured by the method according to the embodiment of the present invention. FIG. 3 is a graph showing results of X-ray diffraction analysis of the TiH₂ powder that is manufactured by the method according to the embodiment of the present invention. FIG. 4 is a graph showing results of DTA analysis of the TiH₂ powder that is manufactured by the method according to the embodiment of the present invention.

As shown in FIG. 1, a method of manufacturing titanium hydride according to the embodiment of the present invention includes charging titanium turning chips and balls into a container, discharging air from the container to make the container vacuum, applying hydrogen pressure to the container, and performing ball milling.

An attrition ball mill is used in the embodiment of the present invention, the diameter of the ball to be used is 9.53 mm, and the apparent amount of charged balls is 50%. Titanium chips corresponding to CP-1 grade, which has titanium content of 99% by weight or more, are used as the titanium turning chips.

After balls and titanium turning chips are charged into the container, air is discharged from the container by a rotary vacuum pump so that the pressure in the container becomes 10² torr. Then, hydrogen gas is supplied to the container so that hydrogen pressure in the container becomes 5 bar.

After the hydrogen gas is supplied to the container, ball milling is performed at 320 rpm for 300 seconds and 570 seconds, respectively, so that the turning chips are hydrogenated and changed into powder. Further, after the ball milling is performed, the powder generated is maintained for 2 hours so that a hydrogenation reaction is sufficiently performed. Ball milling time is shown in Table 1.

TABLE 1
Milling time

| | Milling time | Milling time |
|---|---|---|
| | (seconds) until | (seconds) after |
| Types of specimens | a reaction begins | a reaction begins |
| STC | 300 | 0 |
| 270C | 300 | 270 |

Further, the amount of absorbed hydrogen with respect to milling time is obtained by the following Formula 2 that represents a relationship between the number of hydrogen atoms absorbed in one titanium atom and the pressure of hydrogen gas in the container.

$$\frac{H}{Ti} = \frac{2 V Δ P}{Rm} = \frac{4.274 \times {10}^{- 3} V Δ P}{m} \qquad [ Formula 2 ]$$

where, V: the volume of a system

ΔP: pressure variation of a system

R: standard volume of gas

m: mass of Ti scrap

Further, the crystal structure of the titanium hydride powder obtained by ball milling is compared with the crystal structure of commercial titanium hydride by X-ray diffraction analysis. Further, DTA analysis is performed to obtain dehydrogenation temperature.

When ball milling is performed at 320 rpm, it is possible to understand the followings from FIG. 2. That is, when about 50 seconds passes after the beginning of the ball milling, hydrogen in an atmosphere begins to be absorbed due to the partial hydrogenation reaction. When about 300 seconds passes after the beginning of the ball milling, hydrogenation is actively performed due to the heat of a self-reaction. When about 600 seconds passes after the beginning of the ball milling, hydrogenation is not facilitated even though the ball milling is performed.

It is possible to hydrogenate the STC specimen that is obtained by performing milling for 300 seconds which is the time of beginning self-reaction and the 270 C specimen that is obtained by additionally performing milling for 270 seconds after the self-reaction begins. However the powders hydrogenated are maintained for 2 hours in consideration of an accident caused by hydrogen gas remaining in the container and the stabilization of the generated hydride.

As a result of the X-ray diffraction analysis of the powder that is manufactured by the method according to the embodiment of the present invention, it is possible to understand the followings from FIG. 3. STC powder and 270 C powder, which are manufactured by the method according to the embodiment of the present invention, have the same diffraction peaks as commercial TiH₂ powder. That is, it is possible to understand that the titanium turning chips are completely changed into TiH₂ powder by performing ball milling for about 5 to 10 minutes.

Further, as results of DTA analysis that is performed on the TiH₂ powder manufactured by the method according to the embodiment of the present invention and the commercial TiH₂ powder, it is possible to understand from FIG. 4 that the commercial TiH₂ powder is dehydrogenated at a temperature of about 625° C. And the TiH₂ powder (STC specimen) obtained by performing milling for 300 seconds has results of DTA analysis similar to the commercial powder.

However, in the case of the TiH₂ powder (270 C specimen) obtained by performing milling for about 600 seconds, two dehydrogenation reactions occur. The first dehydrogenation reaction occurs at a temperature of about 500° C., and the second dehydrogenation reaction occurs at a temperature of about 550° C. The reason for this is assumed as follows: as the milling time increases, many defects are formed in the hydride powder. Since the energy barrier of the dehydrogenation is lowered due to the defects, the dehydrogenation is divided into two reactions that include a reaction for forming metastable phase and a reaction for changing metastable phase into stable phase.

1. A method of manufacturing titanium hydride powder comprising:
charging scrap containing titanium into a reaction container;
removing air in the reaction container and supplying hydrogen gas to the reaction container; and
performing ball milling.

2. The method according to claim 1 further comprising:
maintaining the titanium hydride powder for a predetermined time after the performing of the ball milling.

3. The method according to claim 1, wherein the scrap is one of a turning chip, a chip, and powder.

4. The method according to claim 3, wherein the pressure of the hydrogen gas is in the range of 1 to 100 bar.

5. The method according to claim 3, wherein the pressure of the hydrogen gas is in the range of 3 to 20 bar.

6. The method according to claim 3, wherein the ball milling is performed at 50 rpm or more.

7. The method according to claim 6, wherein the ball milling is performed for 60 seconds to 1 hour.

8. The method according to claim 6, wherein the ball milling is performed for 300 seconds to 30 minutes.

9. The method according to claim 2, wherein the scrap is one of a turning chip, a chip, and powder.
